(19) United States
(12) Patent Application Publication
(10) Pub. No.: US 2025/0119789 A1
(43) Pub. Date: Apr. 10, 2025

(54) TECHNOLOGIES FOR DISCARDING MECHANISM

(71) Applicant: APPLE INC., Cupertino, CA (US)

(72) Inventors: Ping-Heng Kuo, London (GB); Sudeep Manithara Vamanan, Nuremberg (DE); Ralf Rossbach, Munich (DE); Waqar Zia, Munich (DE); Haijing Hu, Los Gatos, CA (US)

(73) Assignee: APPLE INC., Cupertino, CA (US)

(21) Appl. No.: 18/889,025

(22) Filed: Sep. 18, 2024

Related U.S. Application Data
(60) Provisional application No. 63/542,711, filed on Oct. 5, 2023.

(51) Int. Cl. H04W 28/06; H04L 65/65; H04W 24/02; H04W 28/02

(52) U.S. Cl. CPC H04W 28/06; H04L 65/65; H04W 24/02; H04W 28/0268

(57) ABSTRACT

The present application relates to devices and components, including apparatus, systems, and methods for discarding packet data units (PDUs).

### CROSS-REFERENCES TO OTHER APPLICATIONS

This application claims priority to U.S. Provisional Application No. 63/542,711, for “TECHNOLOGIES FOR DISCARDING MECHANISM,” filed on Oct. 5, 2023, which is herein incorporated by reference in its entirety for all purposes.

### TECHNICAL FIELD

This application relates generally to communication networks and, in particular, to technologies for discarding packet data units (PDUs).

### BACKGROUND

Congestion control is designed to prevent network overload by regulating the amount of data being sent over the network. The goal of congestion control may be to maintain a high level of network performance even under heavy load conditions. The network may monitor the network performance. When congestion is detected, the system may take appropriate actions to alleviate the congestion.

The network may implement a packet discarding mechanism to control congestion. In packet discarding, the network may selectively discard packets when congestion is detected. Excessive packet discarding, however, may lead to information loss and degrade the overall performance of the network and user experience.

### BRIEF DESCRIPTION OF THE DRAWINGS

FIG. 1 illustrates a network environment in accordance with some embodiments.

FIG. 2 illustrates aspects of the user equipment (UE) in accordance with some embodiments.

FIG. 3 illustrates a signaling diagram in accordance with some embodiments.

FIG. 4 illustrates a signaling diagram in accordance with some embodiments.

FIG. 5 illustrates aspects of the assistance information in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates a user equipment in accordance with some embodiments.

FIG. 9 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

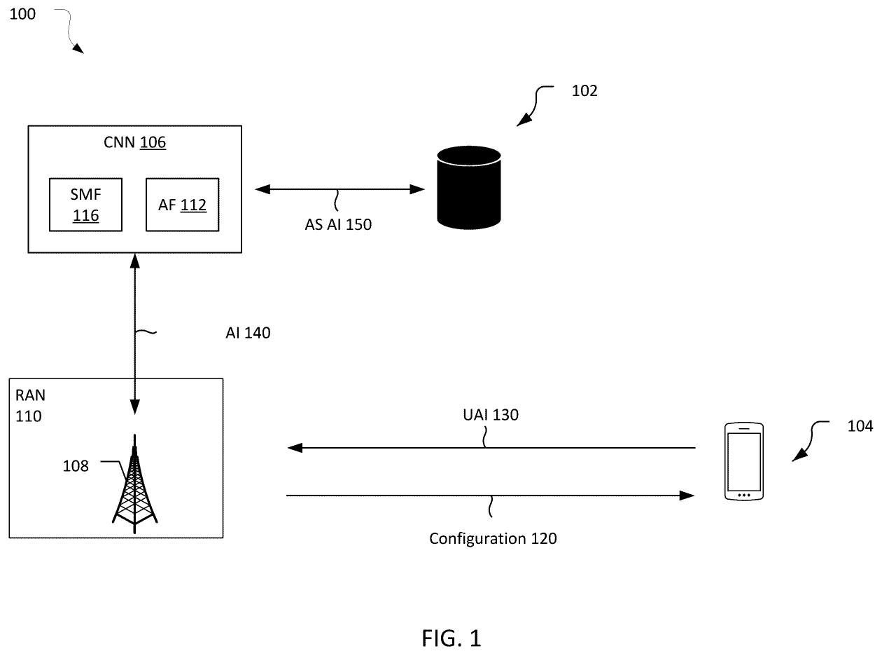

FIG. 1 illustrates a network environment 100 in accordance with some embodiments. The network environment 100 may include a user equipment (UE) 104 communicatively coupled with a base station (BS) 108 of a radio access network (RAN) 110. In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and the base station 108 communicate may be compatible with 3GPP technical specifications (TSs), such as those that define Fifth Generation (5G) NR or later system standards (e.g., Sixth Generation (6G) standards). The base station 108 may provide user plane and control plane protocol terminations toward the UE 104.

The network environment 100 may include a core network node (CNN) 106. For example, the core network node 106 may comprise a 5^{th} Generation Core network (5GC) or a later generation core network. The core network node 106 may be coupled to the base station 108 via a fiber optic or wireless backhaul. The core network node 106 may provide functions for the UE 104 via the base station 108. These functions may include managing subscriber profile information, subscriber location, authentication of services, or switching functions for voice and data sessions.

The core network node 106 may include one or more network functions, e.g., an application function (AF) 112 or a session management function (SMF) 116. The application function 112 may be responsible for accessing the network exposure function (NEF), establishing an interface between the application and application layer, interacting with the policy control function (PCF) for policy control, and providing application services to subscribers.

An application may have a component running on the application server 102. The application may interact with the UE 104 or RAN 110 through the application function 112 of the core network node 106.

The SMF 116 may be responsible for interacting with the access and mobility management function (AMF), PCF, or user plane function (UPF). The SMF 116 may create, update, or remove PDU sessions and manage session context with the UPF.

In some instances, an application associated with an application layer may generate data for transmission. For example, a video stream or a text message. The data generated by the application may be organized into packets at a transport layer. The packets associated with an application may be referred to as a service data flow (SDF).

Each SDF may be mapped to a quality of service (QoS) flow. Each SDF may be associated with a quality of service requirement. The QoS flow associated with an SDF may allocate network resources to provide the required QoS.

One or more QoS flows may be grouped into a protocol data unit (PDU) session for transmission over a network. The PDU session may provide the Internet protocol (IP) connectivity between the UE 104 and the data network.

The UE 104 and base station 108 may establish data radio bearers (DRBs) to support the transmission of data over a wireless link between the two nodes. Each QoS flow may be mapped to a DRB. The DRB may handle the transmission of data over the air interface. In one example, these DRBs may be used for traffic from extended reality (XR) applications that contain a large amount of data conveying real and virtual images and audio for presentation to a user. The data traffic, e.g., packets or PDUs, may be grouped into a PDU set. A PDU set may include one or more PDUs (or packets) carrying the payload of one unit of information generated at the application level. In one example, for XR services, a unit of information generated at the application level may be one or more frames or video slices. All the PDUs of a PDU set may be transmitted within the same QoS flow.

PDU set importance (PSI) may be a parameter associated with a PDU set, a QoS flow, or a DRB. The PSI may indicate the level or importance of the associated packet or PDU set. In one example, the lower the PSI level of a PDU set, the more important the PDU. The PSI-based packet discarding may discard packets based on their associated PSI level.

The UE 104 may discard packets. For example, the packet data convergence protocol (PDCP) sublayer of layer 2 of the 3GPP protocol stack may discard packets mapped to a QoS flow. The DRB may be configured to discard some or the entire PDU set when one of the packets of the PDU set is lost or discarded. For example, the DRB may discard a PDU set based on the objectives of the PDU set integrity handling indication (PSIHI). The PSIHI may indicate whether the application layer may need every packet of a PDU set. In some embodiments, the base station 108 may detect congestion and signal the UE 104 to apply packet discarding mechanisms. The base station 108 may send configuration message 120 to indicate to the UE 104 to apply a PSI-based packet discarding mechanism.

The configuration message 120 may configure the PSI-based packet discarding mechanism. In one instance, the configuration message 120 may configure one or more timers associated with the PSI-based discarding mechanism. For example, a PSI level may be associated with a timer. Upon expiration of the timer, one or more packets having the same PSI level as the PSI level associated with the timer may be discarded.

In another instance, the configuration message 120 may configure a PSI threshold. The PSI threshold may be associated with a QoS flow. Different QoS flows, or different DRBs may have different PSI thresholds. Once the PSI-based packet discarding mechanism is activated, the UE 104 may discard packets or PDU sets of the QoS flow or DRB having a PSI level equal to or larger than the PSI threshold associated with the QoS flow.

Discarding packets may impact the UE's quality of experience. It is desired to reduce the impact of congestion control through packet discarding on the UE's quality of experience. Providing PSI attributes, e.g., statistical parameters associated with the PSI of a QoS flow, a PDU session, or a DRB, may assist the base station 108 in configuring the PSI-based packet discarding at the UE 104 with a consideration of the quality of experience.

In one embodiment, the UE 104 may provide the UE assistance information (UAI) 130 to the RAN 110 and base station 108. The UE assistance information 130 may include one or more PSI attributes, e.g., the range of PSI levels or a statistical distribution of PSI levels associated with a QoS flow or a DRB.

The application server 102 may be communicatively coupled with the core network node 106. In one embodiment, the application server 102 may send the application server assistance information (AS AI) 150 to the base station 108 through the application function 112. The AS AI 150 may include one or more PSI attributes associated with a QoS flow or a DRB of uplink traffic of the UE 104. The application function 112 may configure the base station 108 via an N2 interface, the core network node 106, or the session management function 116.

In one embodiment, the session management function 116 may send assistance information (AI) 140 to the base station 108. The assistance information 140 may include one or more PSI attributes associated with a QoS flow or a DRB of the uplink traffic of the UE 104.

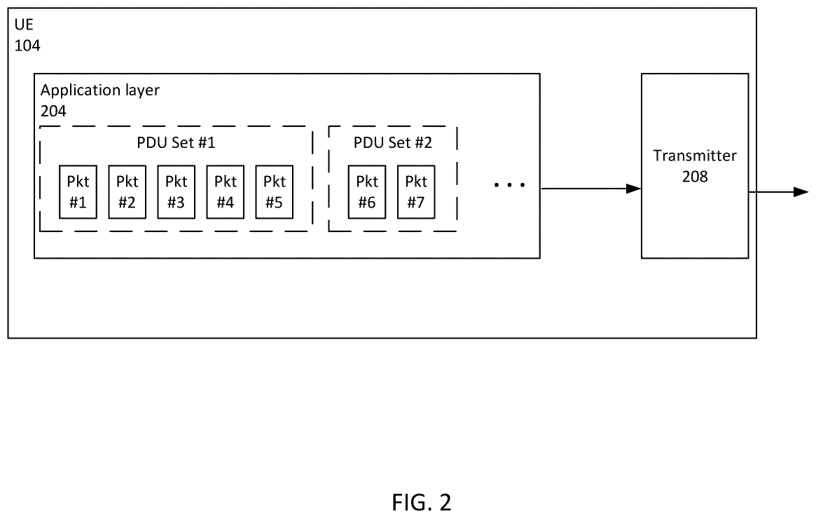

FIG. 2 illustrates aspects of the UE 104 in further detail in accordance with some embodiments. The UE 104 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet, which may also be referred to as a PDU, may be an Internet protocol (IP) packet or a non-IP packet. As shown, PDU set #1 may include packets #1-#5, while PDU set #2 includes packets #6 and #7. Each PDU set may be mapped to a different QoS flow. Different PDU sets may be mapped to different traffic flows when they correspond to different traffic flows or modalities.

The packets of a PDU set may carry a payload of one unit of information generated by the application layer. The unit of information may be a frame or video slice for XR Services, such as those defined in 3GPP Technical Report (TR) 26.926 v18.0.0 (September 2023), for example. In some implementations, all PDUs in the PDU Set may be needed by an application layer at a destination node to allow the application layer to recover parts or all of the information unit. In other implementations, the application layer on the destination node may still be able to recover parts or all of the information unit, even if some PDUs of a PDU set are missing.

In some embodiments, the data produced by an application layer of the UE 104 may include multi-modal data. Multi-modal data may include input data from different kinds of devices/sensors or output data to different kinds of destinations (e.g., one or more UEs) desired for the same task or application. Multi-modal data may include more than one single-modal data (e.g., one type of data), and there may be a strong dependency among each single-modal data associated with multi-modal data.

In some embodiments, the data produced by an application layer may be in a data burst. A data burst may include, for example, data produced by the application layer in a short period of time. The data burst may include PDUs from one or more PDU Sets.

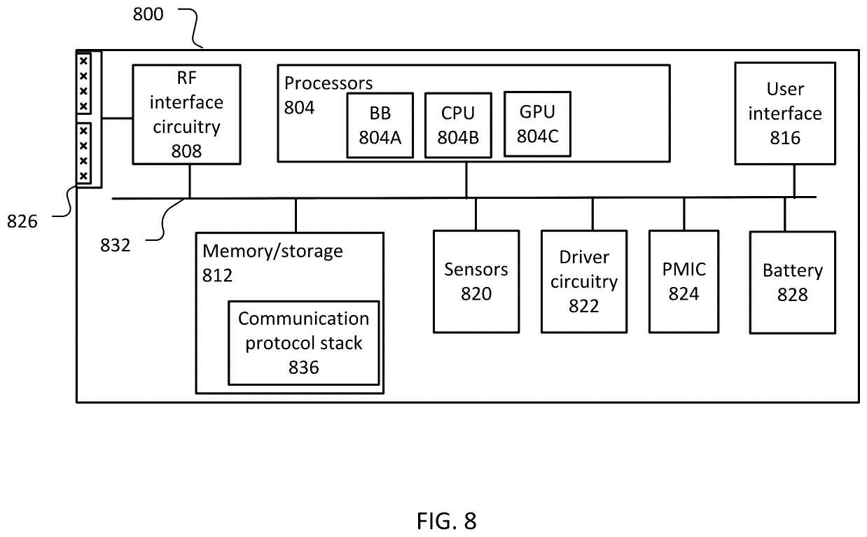

The PDU sets may be provided to a transmitter 208 of the UE 104. The transmitter 208 may be configured to execute a communication protocol stack, for example, communication protocol stack 836 of FIG. 8, to facilitate communication via the network environment 100. The transmitter 208 may implement layer 2 (L2) and layer 1 (L1) functionality. At the L2 level, the transmitter 208 may include a service data adaptation protocol (SDAP) layer, a packet data convergence protocol (PDCP) layer, a radio link control (RLC) layer, and a media access control (MAC) layer. At the L1 level, the transmitter 208 may include a physical (PHY) layer. Briefly, the SDAP layer may manage QoS flow handling between the QoS flows and the DRBs. The PDCP layer may manage robust header (de)compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, various information may be provided by the core network node 106 to the RAN 110 to assist in the handling of QoS flows and PDUs. This information may be consistent with that described in 3GPP TR 23.700-60 v18.0.0 (Dec. 21, 2022). This information may include semi-static information for both uplink and downlink, PDU set QoS parameters, and dynamic information for downlink.

The semi-static information for both uplink and downlink may be provided via the control plane (NGAP). This information may include periodicity for uplink and downlink traffic of the QoS Flow via time-sensitive communications assistance information (TSCAI)/time-sensitive communications assistance container (TSCAC) and traffic jitter information (e.g., jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TR 23.700-60. In some instances, a PDU set may be considered as successfully delivered when all PDUs of a PDU Set are delivered successfully. In other instances, other definitions of successful delivery may be made. In some instances, if one PDU of a PDU set is discarded, all remaining PDUs of the PDU set may be discarded.

The PDU set QoS parameters may further include a PDU Set Delay Budget (PSDB) that defines a time between the reception of a first PDU and the successful delivery of a last-arrived PDU of a PDU Set. See, for example, 3GPP TR 23.700-60. The PSDB may be an optional parameter in various embodiments.

The PDU set QoS parameters may further include a PDU Set importance (PSI) to indicate the relative importance of a PDU set compared to other PDU sets within the same QoS flow.

A PDU set may be associated with the following information: a PDU set sequence number (SN); a PDU set size (in bytes); a PDU SN within a PDU Set; an end PDU of the PDU Set indication; a PDU set importance (PSI); and an end of data burst indication in the header of a last PDU of the data burst. The PSI may be used to identify the importance of a PDU Set within a QoS flow. The RAN 110 may use the PSI for PSI-based discarding in the presence of congestion, as described herein.

The application, application server 102, or application function 112 may assign a PSI level for each packet or PDU set or may define rules and policies for assigning a PSI level to a type of packet or PDU set. For example, the application may assign a PSI level to packets associated with audio data and a different PSI to packets or PDU sets associated with real-time video data. Within a video stream, the application may assign different PSI to payloads associated with different video frame types. PSI level selection may be influenced by factors such as type of application (e.g., video, audio, text), details of codec (e.g., H.264 or high-efficiency video coding, HEVC), level of error propagation when a PDU set is discarded, or inter-dependency among PDU sets (e.g., whether a PDU set is necessary for the processing of some other PDU sets). The PSI selection may be similar to that described in 3GPP TS 26.522 v 0.1.1 (Sep. 23, 2023).

PSI may have N levels, e.g., levels 0 to N−1. The higher PSI level values may be associated with less importance. Some of the PSI levels may indicate no interdependency with other PDU sets. For example, there may be 16 levels of PSIs, e.g., level 0 to level 15. PSI levels 14 and 15 may indicate no inter-dependency to other PDU sets; e.g., a PDU set having PSI level 14 may not have inter-dependency to other PDU sets. PDU sets with other PSI levels, e.g., levels 0 to 13, may be needed for the processing of other PDU sets. These values may differ in other embodiments. The PSI-based discarding mechanism may be configured in a way to strike a balance between congestion handling and user experience. Base station 108 may be able to achieve such a balance by having knowledge related to the PSIs of the UE's applications.

PSI levels may be classified into one or more groups, e.g., 1, 2, or 4 groups. The UE may treat each PSI level group differently when the PSI-based discarding mechanism is activated, e.g., the UE may apply a specific discard timer value (or a separate discard timer) when processing packets with PSI level pertaining to each group, or the UE may directly discard packets with PSI level pertaining to one or more particular groups. For example, the 16 PSI levels of the above example may be classified into two groups, e.g., PSI levels 0˜8 in one group and PSI levels 9˜15 in another group. The grouping may be done based on UE implementation (e.g., the UE application server may interact with the UE application or UE application layer to determine the grouping). The network, e.g., the RAN 110 or the core network node 106, may configure the PSI level groups. For example, the RAN 110 may signal one or more PSI level thresholds for the UE to group the PSI levels accordingly.

Different applications, e.g., video, audio, text, metadata, or image, may have different PDU set marking methods. Therefore, two different applications running on the UE may assign PSI levels in different ways. As a result, the traffic flows associated with different applications may have different distributions of PSI levels. Having the knowledge of PSI distributions associated with a flow may allow base station 108 to configure the PSI-based discarding based on the PSI levels associated with that flow.

In some embodiments, a transmitting device may employ PDU set discarding. The PDU set discarding may be similar to that described in 3GPP TR 38.835 v18.0.1 (Apr. 5, 2023). For example, in some instances, a threshold number of PDUs of a PDU set may be desired for a receiving application layer to use the unit of information. If a transmitting device determines, for example, that the number of lost PDUs of a PDU set exceeds the threshold number, the transmitting device may discard the remaining PDUs of the PDU set without transmission in order to free up radio resources. In some embodiments, a PDU may be determined to be lost if it is unsuccessfully transmitted (e.g., within a required time budget) or discarded before transmission. A PDU may be discarded as described herein or for other reasons, e.g., the PDU depends on another PDU that was lost.

In some instances, the network may configure the UE behavior of uplink PDU set discarding based on the PSI. In particular, PDU sets associated with a QoS flow or DRB having a particular PSI level may be discarded. This may reduce congestion in the network.

PSI-based packet discarding may be more beneficial when the network is congested. When the network is not congested, PDU set discarding may be less useful as radio resource optimization may be relatively less important, and excessive PDU Set discarding could have some adversarial impacts on user experience.

In some instances, the packet discarding based on PSI may be specifically associated with network congestion status. The RAN 110 (e.g., the base station 108) may activate the PSI-based packet discarding at the UE via dedicated signaling. The activation command may be a medium access control (MAC) control element (CE), a PDCP control PDU, or an RRC configuration signaling.

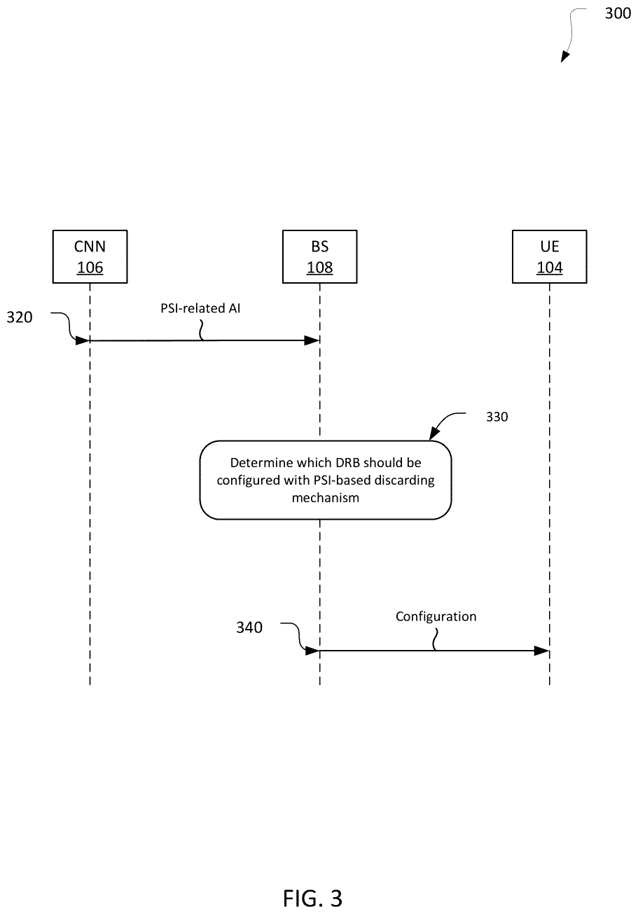

FIG. 3 illustrates a signaling diagram 300 in accordance with some embodiments. Signaling diagram 300 may be an example of providing a PSI attribute to base station 108.

The signaling diagram 300 may include operations and signals between the core network node 106 and the base station 108 and between the base station 108 and the UE 104.

The signaling diagram 300 may include, at 320, the core network node 106 sending assistance information to the base station 108. The assistance information may include one or more PSI attributes associated with at least one QoS flow. An SMF, e.g., SMF 116, may send the information to the base station 108. The assistance information may be provided as an attribute of PDU set QoS parameters. One or more PSI attributes may be added with other assistance information sent from the core network node 106 to the base station 108. For example, the PSI attribute may be added to the TSCAI or TSCAC message. The core network node 106 may send one or more PSI attributes to the base station using a dedicated message or procedure. The SMF may receive respective PSI attributes from the application function 112 or from the application server 102.

An application server, e.g., application server 102, may provide one or more PSI attributes to the base station 108. The application server 102 may use application function 112 to configure the base station 108, e.g., via an N2 interface or via the core network node 106 or the SMF 116.

The signaling diagram 300 may include, at 330, the base station 108 determining which DRB could (or should be) be configured with a PSI-based discarding mechanism. For example, based on the congestion condition or the assistance information from the core network node 106, the base station 108 may determine a DRB or a QoS flow to which the UE 104 may apply a PSI-based discarding mechanism.

The signaling diagram 300 may include, at 340, the base station 108 sending a message to the UE 104. The message may configure or activate a PSI-based discarding mechanism. The message may identify one or more flows (a flow may be a DRB, a QoS flow, or a PDU session) and activate the PSI-based discarding mechanism for the identified flows. The UE may apply a PSI-based discarding mechanism to the identified flows.

The message may configure a timer for each PSI level or each PSI level group associated with every identified flow, one timer for each PSI level or PSI level group, one timer for each flow, or one timer for all identified flows. The base station 108 may configure or activate the PSI-based discarding mechanism in multiple messages. The UE 104, the base station 108, or the core network node 106 may trigger updating the configuration or activation or PSI-based discarding mechanism associated with a flow. For example, the UE application, the application server at the UE, the application server 102, the SMF 112, or a function or entity associated with the core network node 106 may trigger the update procedure.

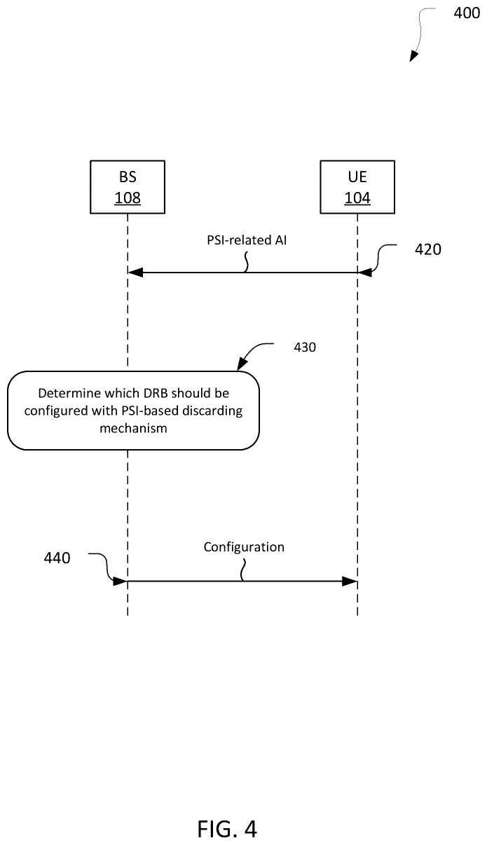

FIG. 4 illustrates a signaling diagram 400 in accordance with some embodiments. Signaling diagram 400 may be an example of providing a PSI attribute to base station 108. The signaling diagram 400 may include operations and signals between the UE 104.

The signaling diagram 400 may include, at 420, the UE 104 sending assistance information to the base station 108. The assistance information may include one or more PSI attributes associated with at least one QoS flow or DRB. For example, the UE may send the assistance information with UE assistance information (UAI). The application server running in the UE 104 may obtain the PSI attributes based on its interaction with UE's application layer. The UE application server may obtain PSI attributes based on its interaction, e.g., message exchange, with application server 102.

The signaling diagram 400 may include, at 430, the base station 108 determining which DRB could be (or should be) configured with a PSI-based discarding mechanism. For example, based on the congestion condition or the assistance information from the UE 104, the base station 108 may determine a DRB or a QoS flow to which the UE 104 may apply a PSI-based discarding mechanism.

The signaling diagram 400 may include, at 440, the base station 108 sending a message to the UE 104. The message may configure or activate a PSI-based discarding mechanism. The message may identify one or more flows (a flow may be a DRB, a QoS flow, or a PDU session) and activate the PSI-based discarding mechanism for the identified flows. The UE may apply a PSI-based discarding mechanism to the identified flows.

The message may configure a timer for each PSI level or each PSI level group associated with every identified flow, one timer for each PSI level or PSI level group, one timer for each flow, or one timer for all identified flows. The base station 108 may configure or activate the PSI-based discarding mechanism in multiple messages. The UE 104, the base station 108, or the core network node 106 may trigger updating the configuration or activation or PSI-based discarding mechanism associated with a flow. For example, the UE application, the application server at the UE, the application server 102, the SMF 112, or a function or entity associated with the core network node 106 may trigger the update procedure.

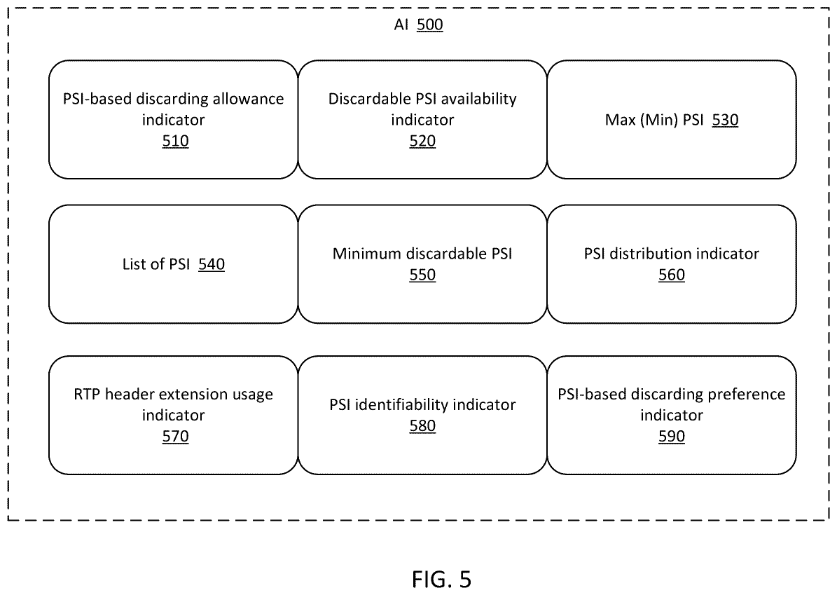

FIG. 5 illustrates aspects of the assistance information 500 in accordance with some embodiments. The core network node 106, the application server 102, or the UE 104 may send a message to the base station 108 to assist with the configuration of the PSI-based discarding mechanism. The message may include assistance information 500, which may contain one or more of PSI attributes 510-580.

In one embodiment, the assistance information 500 may include a PSI attribute, where the PSI attribute is a PSI-based discarding allowance indicator 510. The PSI-based discarding allowance indicator 510 may include one or more flow indicators. Each flow indicator may be associated with a flow, e.g., a PDU session, a DRB, or a QoS flow. Each flow indicator may indicate whether the PSI-based discarding mechanism is allowed to be configured or activated for the corresponding flow. For example, the UE may determine that packets associated with an application may not be dropped, discarded, or processed with a different discard timer value, e.g., due to QoS or quality of experience objectives or the specific nature of the application. The UE may inform the base station by setting the flow indicator associated with that flow in the PSI-based discarding allowance indicator 510 to indicate that the PSI-based discarding mechanism is not allowed for that flow.

In some instances, the flow indicator may be one bit of information associated with a flow. The value ‘0’ may indicate that PSI-based discarding is not allowed for the corresponding flow. The value ‘1’ may indicate that PSI-based discarding is allowed for the corresponding flow. These values may differ in other embodiments.

In one embodiment, the assistance information 500 may include preference information of the core network node 106, the application server 102, or the UE 104. The preference information may indicate one or more flows, e.g., PDU sessions, DRBs, or QoS flows, that are preferred to be configured with PSI-based discarding when needed, e.g., when congestion occurs. The preference information may indicate whether PSI-based discarding is preferred to be activated for the indicated one or more flows when needed, e.g., when congestion occurs.

The UE may inform the base station by setting the flow indicator associated with a flow in the PSI-based discarding preference indicator 590 to indicate that the PSI-based discarding is preferred or not preferred for that flow. In some instances, the flow indicator may be one bit of information associated with a flow. The value ‘0’ may indicate that PSI-based discarding is not preferred for the corresponding flow. The value ‘1’ may indicate that PSI-based discarding is preferred for the corresponding flow. These values may differ in other embodiments.

In one embodiment, the assistance information 500 may include a PSI attribute, where a PSI attribute is the discardable PSI availability indicator 520. The discardable PSI availability indicator 520 may indicate whether the UE has any packet associated with a discardable PSI level.

For example, the UE may be configured to drop or apply a different discard timer value to packets when the packet has a preconfigured PSI level and packets are associated with a flow configured with a PSI-based discarding mechanism. The UE may be configured with one or more preconfigured PSI levels that are considered as discardable PSI levels. The discardable PSI availability indicator 520 may have one or more fields, each field associated with a flow, e.g., a PDU session, a DRB, or a QoS flow. Each field may have one or more PSI indicators, each PSI indicator associated with a preconfigured PSI level, which may indicate whether the flow includes packets or PDU sets having the corresponding preconfigured PSI level.

Each field in the discardable PSI availability indicator 520 may include additional information associated with the corresponding preconfigured PSI level. For example, the field may indicate a likelihood, e.g., a probability, associated with the corresponding preconfigured PSI level. The field may indicate how often the corresponding preconfigured PSI level may occur. The field may indicate that the portion of PDU sets with the corresponding preconfigured PSI level can be expected on the associated flow.

In some instances, the UE may be configured to discard or apply different discard timer values to PDU sets with preconfigured PSI levels when congestion is detected or when an activation command of a PSI-based discarding mechanism is received from the base station. The discardable PSI availability indicator 520 may indicate whether there is any PDU set with such specific PSI levels in the corresponding flow. In some instances, the preconfigured PSI levels may be PSI levels 14 or 15, as PDU Sets with these PSI levels may not be necessary for the processing of any other PDU Sets.

In one embodiment, the assistance information 500 may include a PSI attribute, where the PSI attribute is a max (or min) PSI 530. The max (or min) PSI 530 may indicate the range of PSI levels that can be expected on a QoS flow. For example, the max (or min) PSI 530 may have one or more fields. Each field may be associated with a flow, e.g., a PDU session, a DRB, or a QoS flow. Each field may indicate the maximum (or the largest) PSI level, minimum (or the smallest) PSI level, or a range of PSI levels associated with the flow, e.g., both the smallest and largest PSI levels. For example, the field may indicate the maximum PSI level, which is the maximum PSI level of packets or PDU sets associated with the flow. The base station may use the max (or min) PSI 530 to determine a PSI threshold for a flow and configure the UE to discard or apply a different discard timer value to PDU sets or packets with a PSI level larger than (or equal to) the flow's associated PSI threshold.

In one embodiment, the assistance information 500 may include a PSI attribute, where the PSI attribute is the list of available PSI 540. The attribute may indicate PSI levels that can be expected on a flow. The base station may use this attribute to determine a PSI threshold for the flow and to configure the UE to discard or apply a different discard timer value to PDU sets or packets with a PSI level larger than (or equal to) the associated PSI threshold.

For example, the list of available PSI 540 may include one or more fields, each field associated with a flow, e.g., a PDU session, a DRB, or a QoS flow. Each field may indicate the PSI levels that can be expected on that flow. For example, the field may have 16 bits, one bit for each PSI level, e.g., the first bit may be associated with PSI level 0, and bit 16 may be associated with PSI level 15. A value ‘0’ of a bit may indicate that the corresponding PSI level is not expected on that flow, and a value ‘1’ of a bit may indicate that the corresponding PSI level is expected on that flow. These values may differ in other embodiments.

In one embodiment, the assistance information 500 may include a PSI attribute, where the PSI attribute is the minimum discardable PSI 550. The minimum discardable PSI 550 may indicate the minimum PSI level that can be discarded or processed with a different discard timer value. The UE or the network may determine the minimum PSI level that can be discarded or processed with a different discard timer value based on the application layer objectives, such as QoS, quality of experience, or tolerable performance degradation.

For example, the minimum discardable PSI 550 may include one or more fields, each field associated with a flow, e.g., a PDU session, a DRB, or a QoS flow. Each field may indicate the minimum PSI level that can be discarded. The base station may use this attribute to determine a PSI threshold for the flow and to configure the UE to discard or apply a different discard timer to PDU sets or packets with a PSI level larger than (or equal to) the associated PSI threshold.

In one embodiment, the assistance information 500 may include a PSI attribute, where the PSI attribute is a PSI distribution indicator 560. The PSI distribution indicator 560 may include distribution information associated with PSIs. The PSI distribution indicator 560 may indicate the portion, e.g., in percentage, of the number of PDUs, number of PDU sets, or data size, e.g., in bytes, associated with different PSI levels on a flow.

For example, the PSI distribution indicator 560 may include one or more fields, each field associated with a flow, e.g., a PDU session, a DRB, or a QoS flow. Each field may indicate the portion, e.g., in percentage, of the number of PDUs, number of PDU sets, or data size, e.g., in bytes, associated with different PSI levels on the corresponding flow.

In one embodiment, the assistance information 500 may include a PSI attribute, where the PSI attribute is a real-time transport protocol (RTP) header extension usage indicator 570. The RTP header extension usage indicator 570 may indicate whether the application implements an RTP header extension.

In some instances, the application may convey the PSI in the RTP header extension. The UE may rely on the RTP header extension to identify uplink PSI. However, suppose the application does not use, employ, or implement RTP header extension. In that case, the UE may not be able to identify the PSI level of the packets associated with that application. The real-time transport protocol (RTP) header extension usage indicator 570 may inform the base station about the traffic flows that UE is able to identify PSI.

For example, the real-time transport protocol (RTP) header extension usage indicator 570 may include one or more fields, each field associated with a flow, e.g., a PDU session, a DRB, or a QoS flow. Each field may indicate whether the application implements an RTP header extension on that flow.

In one embodiment, the assistance information 500 may include a PSI attribute, where the PSI attribute is a PSI identifiability indicator 580. The PSI identifiability indicator 580 may indicate on which flow the UE is able to identify the uplink PSI.

For example, the PSI identifiability indicator 580 may include one or more fields, each field associated with a flow, e.g., a PDU session, a DRB, or a QoS flow. Each field may indicate whether the UE is able to identify the uplink PSI on that flow. In another example, the PSI identifiability indicator 580 may be a single bit that, if set to ‘0’, may indicate that the UE cannot identify any uplink PSI on any flow.

In real-time applications, the PSI attribute may be based on PSI levels associated with buffered traffic. The PSI levels may be based on time-series estimation of the past PSI levels.

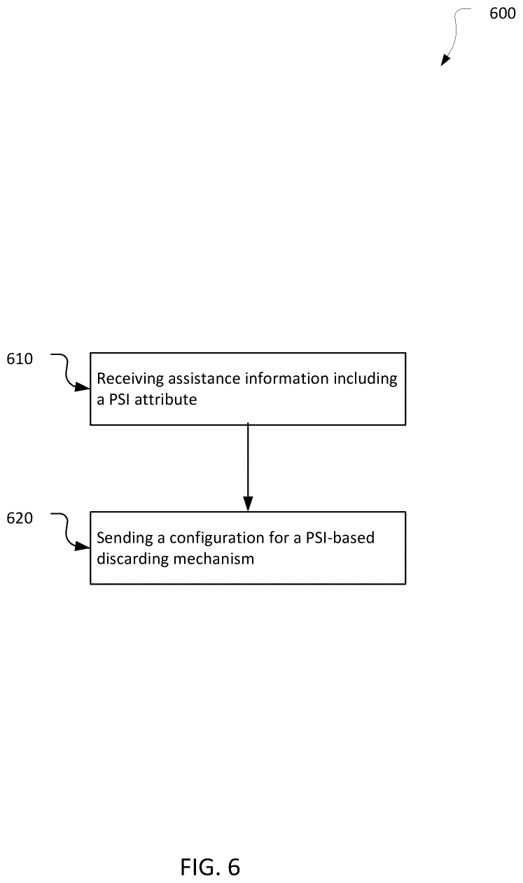

FIG. 6 illustrates an operational flow/algorithmic 600 structure in accordance with some embodiments. Operational flow/algorithmic structure 600 is an example of the operation of the base station 108. The operational flow/algorithmic structure 600 may be implemented by a network node, for example, the network node 900, or components therein, e.g., processors 904.

The operation flow/algorithmic structure 600 may include, at 610, receiving assistance information, including a PSI attribute. The PSI attribute may be associated with a flow. The flow may be a traffic flow, a PDU session, a QoS flow, or a DRB.

The PSI attribute may be a PSI-based discarding allowance indicator, a PSI-based discarding preference indicator, a discardable PSI availability indicator, a maximum expected PSI indicator, a minimum expected PSI indicator, an expected PSI range indicator, a list of available PSI, a minimum discardable PSI indicator, a PSI distribution indicator, a real-time transport protocol (RTP) header extension usage indicator, or a PSI identifiability indicator associated with a flow.

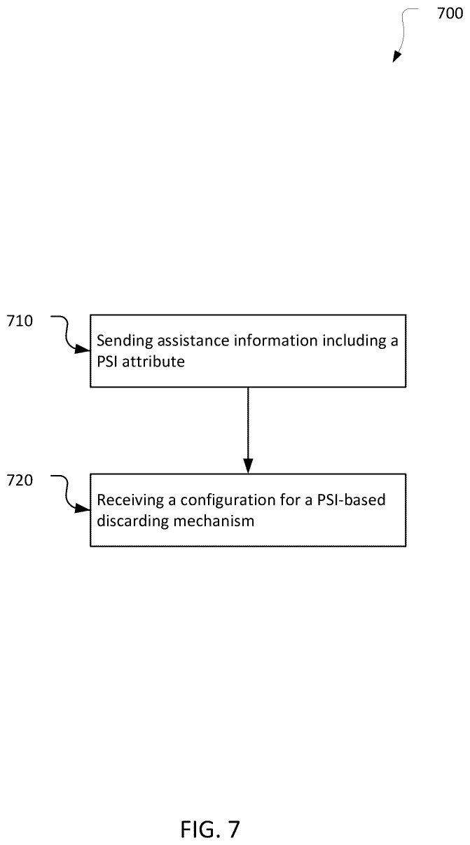

FIG. 7 illustrates an operational flow/algorithmic structure 700 in accordance with some embodiments. Operational flow/algorithmic structure 700 is an example of the UE providing PSI attribute information to the base station. The operation flow/algorithmic structure 700 may be implemented by a UE (for example, UE 104 or UE 800) or components therein, for example, processing circuitry 804.

The operation flow/algorithmic structure 700 may include, at 710, sending assistance information, including a PSI attribute. The UE may send a message to the base station, including the PSI attribute. The PSI attribute may be associated with a flow. The flow may be a traffic flow, a PDU session, a QoS flow, or a DRB.

The PSI attribute may be a PSI-based discarding allowance indicator, a PSI-based discarding preference indicator, a discardable PSI availability indicator, a maximum expected PSI indicator, a minimum expected PSI indicator, an expected PSI range indicator, a list of available PSI, a minimum discardable PSI indicator, a PSI distribution indicator, a real-time transport protocol (RTP) header extension usage indicator, or a PSI identifiability indicator associated with a flow.

The operation flow/algorithmic structure 700 may include, at 720, receiving a configuration for a PSI-based discarding mechanism. The UE may receive a message from the base station, including a configuration or activation associated with a PSI-based discarding.

The UE may detect a trigger to update the PSI attributes. The UE may send to the base station a message with updated PSI attributes.

FIG. 8 illustrates a UE 800 in accordance with some embodiments. The UE 800 may be similar to and substantially interchangeable with UE 104 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface circuitry (for example, processor interface or memory interface), input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP-compatible network. In general, the baseband processor circuitry 804A may access the communication protocol stack 836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 812 may include one or more non-transitory, computer-readable media that includes instructions (for example, the communication protocol stack 836) that may be executed by one or more of the processors 804 to cause the UE 800 to perform various operations described herein. The memory/storage 812 includes any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processor 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands, including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various I/O devices that may be present within or connected to the UE 800. For example, the driver circuitry 822 may include circuitry to facilitate the coupling of a universal integrated circuit card (UICC) or a universal subscriber identity module (USIM) to the UE 800. For additional examples, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage the power provided to various components of the UE 800. In particular, with respect to the processors 804, the PMIC 824 may control power-source selection, voltage scaling, battery charging, or DC-to-DC conversion.

In some embodiments, the PMIC 824 may control or otherwise be part of various power-saving mechanisms of the UE 800, including DRX, as discussed herein.

A battery 828 may power the UE 800, although in some examples, the UE 800 may be mounted and deployed in a fixed location and may have a power supply coupled to an electrical grid. The battery 828 may be a lithium-ion battery, a metal-air battery, such as a zinc-air battery, an aluminum-air battery, a lithium-air battery, and the like. In some implementations, such as in vehicle-based applications, the battery 828 may be a typical lead-acid automotive battery.

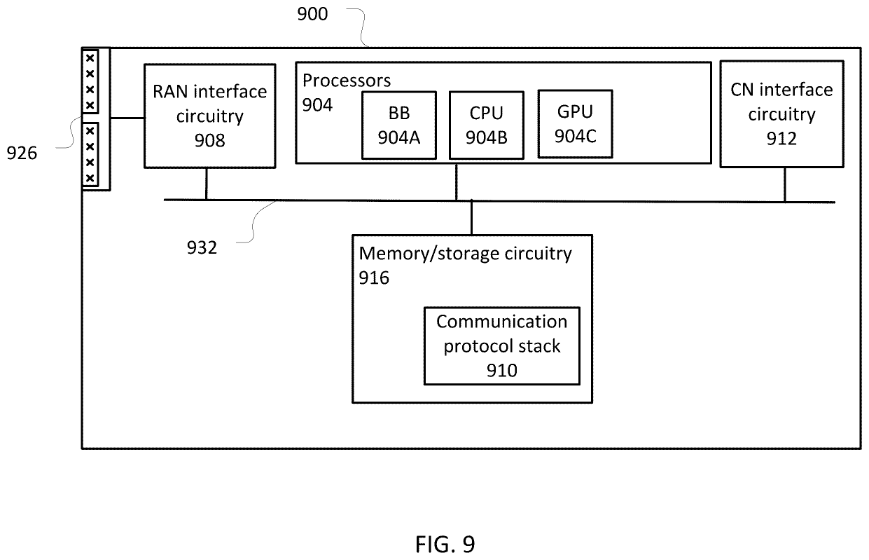

FIG. 9 illustrates a network node 900 in accordance with some embodiments. The network node 900 may be similar to and substantially interchangeable with base station 108, a device implementing one of the network hops, an integrated access and backhaul (IAB) node, a network-controlled repeater, or a server in a core network or external data network.

The network node 900 may include processors 904, RF interface circuitry 908 (if implemented as an access node), the core node (CN) interface circuitry 912, memory/storage circuitry 916, and antenna structure 926.

The components of the network node 900 may be coupled with various other components over one or more interconnects 932.

The processors 904, RF interface circuitry 908, memory/storage circuitry 916 (including communication protocol stack 910), antenna structure 926, and interconnects 932 may be similar to the like-named elements shown and described with respect to FIG. 8.

The CN interface circuitry 912 may provide connectivity to a core network, for example, a 5th Generation Core network (5GC) using a 5GC-compatible network interface protocol such as carrier Ethernet protocols or some other suitable protocol. Network connectivity may be provided to/from the network node 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

In some embodiments, the network node 900 may be coupled with transmit-receive points (TRPs) using the antenna structure 926, CN interface circuitry, or other interface circuitry.

It is well understood that the use of personally identifiable information should follow privacy policies and practices generally recognized as meeting or exceeding industry or governmental requirements for maintaining users' privacy. In particular, personally identifiable information data should be managed and handled to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method to be implemented by a base station (BS), the method including: receiving, from a network node, assistance information including a protocol data unit (PDU) set importance (PSI) attribute associated with a flow; and sending, to a user equipment (UE), a configuration associated with a PSI-based discarding mechanism.

Example 2 includes the method of example 1 or other examples herein, wherein the wherein the PSI attribute includes a PSI-based discarding allowance indicator, the method further includes: determining, based on the PSI-based discarding allowance indicator, whether PSI-based discarding is allowed for the flow.

Example 3 includes the method of examples 1 or 2 or other examples herein, wherein the PSI attribute includes a discardable PSI availability indicator, the method further includes: determining, based on the discardable PSI availability indicator, whether the flow is expected to include a PDU associated with a predetermined PSI.

Example 4 includes the method of any of examples 1-3 or other examples herein, wherein the PSI attribute includes a PSI-based discarding preference indicator, the method further includes: determining, based on the PSI-based discarding preference indicator, whether PSI-based discarding is preferred for the flow.

Example 5 includes the method of any of examples 1-4 or other examples herein, wherein the PSI attribute includes a minimum expected PSI indicator, the method further includes: determining, based on the minimum expected PSI indicator, a smallest expected PSI level associated with a PDU of the flow.

Example 6 includes the method of any of examples 1-5 or other examples herein, wherein the PSI attribute includes an expected PSI range indicator, the method further includes: determining, based on the expected PSI range indicator, an expected PSI range associated with one or more PDUs of the flow.

Example 7 includes the method of any of examples 1-6 or other examples herein, wherein the PSI attribute includes a list of available PSIs, the method further includes: determining, based on the list of available PSIs, one or more expected PSI levels associated with one or more PDUs of the flow.

Example 8 includes the method of any of examples 1-7 or other examples herein, wherein the PSI attribute includes a minimum discardable PSI indicator, the method further includes: determining, based on the minimum discardable PSI indicator, a first PSI level; and determining that a PDU associated with the flow having a second PSI level larger than or equal to the first PSI level can be discarded by the PSI-based discarding mechanism.

Example 9 includes the method of any of examples 1-8 or other examples herein, wherein the PSI attribute includes a PSI distribution indicator, the method further includes: determining, based on the PSI distribution indicator, distribution information of a PSI level associated with the flow.

Example 10 includes the method of any of examples 1-9 or other examples herein, wherein the distribution information is associated with: a number of PDUs of the flow having the PSI level; a number of PDU sets having the PSI level; or a data size associated with the flow having the PSI level.

Example 11 includes the method of any of examples 1-10 or other examples herein, wherein the PSI attribute includes a real-time transport protocol (RTP) header extension usage indicator, the method further includes: determining, based on the RTP header extension usage indicator, whether an application associated with the flow implements an RTP header extension; and determining, based on the RTP header extension usage indicator, whether the UE can determine a PSI level of a PDU associated with the application.

Example 12 includes the method of any of examples 1-11 or other examples herein, wherein the PSI attribute includes a PSI identifiability indicator associated with a flow, the method further includes: determining, based on the PSI identifiability indicator, whether the UE is able to determine a PSI level associated with the flow.

Example 13 includes the method of any of examples 1-2 or other examples herein, wherein the flow is a traffic flow, a QoS flow, or a data radio bearer (DRB) associated with the PSI attribute.

Example 14 includes the method of any of examples 1-13 or other examples herein, wherein the network node is a core network node, an application server, or the UE.

Example 15 includes the method of any of examples 1-14 or other examples herein, wherein the network node is a core network node, and the attribute of the PSI is a parameter of PDU set QoS parameters.

Example 16 includes the method of any of examples 1-15 or other examples herein, wherein the network node is a core network node, and the attribute of the PSI is included in a time sensitive communications assistance information (TSCAI) or a time sensitive communications assistance container (TSCAC).

Example 17 includes the method of any of examples 1-16 or other examples herein, wherein the network node is the UE, and the assistance information is a UE assistance information (UAI).

Example 18 includes the method of any of examples 1-17 or other examples herein, wherein the PSI attribute includes a maximum expected PSI indicator, the method further includes: determining, based on the maximum expected PSI indicator, a largest expected PSI level associated with a PDU of the flow.

Example 19 includes a method to be implemented by a user equipment (UE), the method including: sending, to a base station (BS), assistance information including a protocol data unit (PDU) set importance (PSI) attribute associated with a flow; and receiving, from the BS, a configuration associated with a PSI-based discarding mechanism.

Example 20 includes the method of examples 19 or other examples herein, wherein the PSI attribute is: a PSI-based discarding allowance indicator; a PSI-based discarding preference indicator; a discardable PSI availability indicator; a maximum expected PSI indicator; a minimum expected PSI indicator; an expected PSI range indicator; a list of available PSI; a minimum discardable PSI indicator; a PSI distribution indicator; a real-time transport protocol (RTP) header extension usage indicator; or a PSI identifiability indicator associated with a flow.

Example 21 includes the method of examples 19 or 20 or other examples herein, wherein the flow is a traffic flow, the QoS flow, or a data radio bearer (DRB).

Example 22 includes the method of any of examples 19-21 or other examples herein, wherein: the PSI attribute is a PSI distribution indicator associated with distribution information of a PSI level; and the distribution information is associated with: a number of PDUs of the flow having the PSI level, a number of PDU sets having the PSI level, or a size of data, the data associated with the PSI level, and the data associated with the flow.

Example 23 includes the method of any of examples 19-22 or other examples herein, wherein the PSI attribute is a first PSI attribute and the method further includes: detecting, a trigger to update the first PSI attribute; and sending, to the BA and based on the trigger, a second PSI attribute.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example includes a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing assistance information received from a network node, the assistance information including a protocol data unit set importance (PSI) attribute associated with a flow; and
generating a configuration for transmitting to a user equipment (UE), the configuration associated with a PSI-based discarding mechanism.

2. The method of claim 1, wherein the PSI attribute includes a PSI-based discarding allowance indicator and the method further comprises:
determining, based on the PSI-based discarding allowance indicator, whether PSI-based discarding is allowed for the flow.

3. The method of claim 1, wherein the PSI attribute includes a PSI-based discarding preference indicator and the method further comprises:
determining, based on the PSI-based discarding preference indicator, whether the PSI-based discarding is preferred for the flow.

4. The method of claim 1, wherein the PSI attribute includes a discardable PSI availability indicator and the method further comprises:
determining, based on the discardable PSI availability indicator, whether the flow is expected to include a PDU associated with a predetermined PSI.

5. The method of claim 1, wherein:
the PSI attribute includes a maximum expected PSI indicator and the method further comprises determining, based on the maximum expected PSI indicator, a largest expected PSI level associated with a protocol data unit (PDU) of the flow;
the PSI attribute includes a minimum expected PSI indicator and the method further comprises determining, based on the minimum expected PSI indicator, a smallest expected PSI level associated with a PDU of the flow; or
the PSI attribute includes an expected PSI range indicator and the method further comprises determining, based on the expected PSI range indicator, an expected PSI range associated with one or more PDUs of the flow.

6. The method of claim 1, wherein the PSI attribute includes a list of available PSIs and the method further comprises:
determining, based on the list of available PSIs, one or more expected PSI levels associated with one or more protocol data units (PDUs) of the flow.

7. The method of claim 1, wherein the PSI attribute includes a minimum discardable PSI indicator and the method further comprises:
determining, based on the minimum discardable PSI indicator, a first PSI level; and
determining that a protocol data unit (PDU) associated with the flow having a second PSI level larger than or equal to the first PSI level can be discarded by the PSI-based discarding mechanism.

8. The method of claim 1, wherein the PSI attribute includes a PSI distribution indicator and the method further comprises:
determining, based on the PSI distribution indicator, distribution information of a PSI level associated with the flow, wherein the distribution information is associated with:
a number of protocol data units (PDUs) of the flow having the PSI level;
a number of PDU sets having the PSI level; or
a data size associated with the flow having the PSI level.

9. The method of claim 1, wherein the PSI attribute includes a real-time transport protocol (RTP) header extension usage indicator and the method further comprises:
determining, based on the RTP header extension usage indicator, whether an application associated with the flow implements an RTP header extension; and
determining, based on the RTP header extension usage indicator, whether the UE can determine a PSI level of a protocol data unit (PDU) associated with the application.

10. The method of claim 1, wherein the PSI attribute includes a PSI identifiability indicator associated with a flow and the method further comprises:
determining, based on the PSI identifiability indicator, whether the UE is able to determine a PSI level associated with the flow.

11. The method of claim 10, wherein:
the flow is a quality of service (QoS) flow; and
the network node is the UE.

12. The method of claim 1, wherein the network node is a core network node and the attribute of the PSI is a parameter of protocol data unit (PDU) set quality of service (QoS) parameters.

13. The method of claim 1, wherein the network node is a core network node and the attribute of the PSI is included in a time sensitive communications assistance information (TSCAI) or a time sensitive communications assistance container (TSCAC).

14. The method of claim 1, wherein the network node is the UE and the assistance information is UE assistance information (UAI).

15. An apparatus comprising:
processing circuitry to:
generate assistance information for transmitting to a base station (BS), the assistance information including a protocol data unit set importance (PSI) attribute associated with a flow, wherein the flow is a traffic flow, a quality of service (QoS) flow, or a data radio bearer (DRB); and
process a configuration received from the BS, the configuration associated with a PSI-based discarding mechanism; and
interface circuitry coupled with the processing circuitry to enable communication.

16. The apparatus of claim 15, wherein the PSI attribute is:
a PSI-based discarding allowance indicator;
a PSI-based discarding preference indicator;
a discardable PSI availability indicator;
a maximum expected PSI indicator;
a minimum expected PSI indicator;
an expected PSI range indicator;
a list of available PSI;
a minimum discardable PSI indicator;
a PSI distribution indicator;
a real-time transport protocol (RTP) header extension usage indicator; or
a PSI identifiability indicator associated with the flow.

17. The apparatus of claim 15, wherein
the PSI attribute is a PSI distribution indicator associated with distribution information of a PSI level; and
the distribution information of the PSI level is associated with:
a number of protocol data units (PDUs) of the flow having the PSI level,
a number of PDU sets having the PSI level, or
a size of data, the data associated with the PSI level, and the data associated with the flow.

18. The apparatus of claim 15, wherein the flow is a quality of service (QoS) flow and the PSI attribute includes a PSI identifiability indicator to indicate whether a user equipment is able to identify a PSI level for the QoS flow.

19. One or more non-transitory, computer-readable media having instructions that are to be executed to cause processing circuitry to:
generate assistance information for transmitting to a base station (BS), the assistance information to include a protocol data unit set importance (PSI) attribute associated with a flow, wherein the flow is a traffic flow, a quality of service (QoS) flow, or a data radio bearer (DRB); and
process a configuration, received from the BS, associated with a PSI-based discarding mechanism.

20. The one or more non-transitory, computer-readable media of claim 19, wherein the flow is a quality of service (QoS) flow and the PSI attribute includes a PSI identifiability indicator to indicate whether a user equipment (UE) is able to identify a PSI level associated with the QoS flow.
